(19) United States
(12) Patent Application Publication
(10) Pub. No.: US 2015/0176698 A1
(43) Pub. Date: Jun. 25, 2015

(54) GEAR, GEAR TRAIN, ENGINE, USE THEREOF AND METHOD FOR MATING SUCH GEAR WITH AT LEAST ONE FURTHER GEAR WITH A PREDETERMINED BACKLASH

(71) Applicant: VCST Industrial Products, Sint-Truiden (BE)

(72) Inventor: Bart Vandewal, Aiken (BE)

(73) Assignee: VCST INDUSTRIAL PRODUCTS, Sint-Truiden (BE)

(21) Appl. No.: 14/578,231

(22) Filed: Dec. 19, 2014

(30) Foreign Application Priority Data
Dec. 20, 2013 (EP) 13199221.6

(51) Int. Cl. F16H 57/12; F16H 57/023; F16H 1/26

(52) U.S. Cl. CPC F16H 57/12; F16H 1/26; F16H 57/023; F16H 2057/125

(57) ABSTRACT

Gear (1), for example an idler gear (2), comprising a gear ring (3) rotationally mounted around a gear hub (4), the gear hub (4) comprising an axial gear hub opening (5), wherein the gear (1) comprises displacement means (6) in the gear hub opening (5), the displacement means (6) being provided for predeterminedly translating the centre of rotation of the gear ring (3) by moving the gear ring (3) and the gear hub (4) with respect to the centre of rotation of at least one further gear (7) from a first predetermined position in which the gear mates with the at least one further gear with substantially no backlash to a second predetermined position in which the gear mates with the at least one further gear with a predetermined backlash.

The present invention relates to a gear according to the preamble of the first claim.

The tooth profile interlocking clearance between two mating gears of, for example a gear transmission, the backlash, and in particular the rotational backlash, is known to create a hydrodynamic lubrication, compensating for dimensional changes caused by temperature effects, preventing abrasion or premature wear of the shaft, axles and toothed gears, and compensating bad construction and assembly work. In the serial production of engines, gears or other aggregates, providing a predetermined backlash to two or more toothed gears in mesh (serrated, helical, or other) pressed, screwed or secured otherwise onto driven or secondary shafts, requires elaborate alignment equipment or alignment devices.

WO9300530 for example describes an idler gear and a method for providing a predetermined backlash to an idler gear and two gears mating with the idler gear.

However, with an idler gear according to WO9300530, it remains difficult to provide a predetermined backlash of the idler gear and the two gears mating with the idler gear as positioning the centre of rotation of the gear ring is quite arbitrary and still elaborate alignment is required.

Therefore, it is an object of the present invention to provide a gear with which the backlash between the gear and at least one further gear can be more easily established.

This is achieved according to the present invention with the technical features of the characterizing part of the first claim.

Thereto, the gear comprises displacement means in the axial gear hub opening, the displacement means being provided for predeterminedly translating the centre of rotation of the gear ring by moving the gear ring and the gear hub with respect to the centre of rotation of at least one further gear from a first predetermined position in which the gear mates with the at least one further gear with substantially no backlash to a second predetermined position in which the gear mates with the at least one further gear with a predetermined backlash.

Such displacement means have been found to more easily allow positioning the gear with respect to the at least one further gear with a predetermined backlash as the operator mounting the gear to the at least one further gear only needs to put the gear in the first predetermined position with respect to the at least one further gear after which the displacement means will allow a predetermined translation of the centre of rotation of the gear ring from that first position to the second predetermined position in which the gear mates with the at least one further gear with a predetermined backlash.

According to preferred embodiments of the gear according to the present invention, the gear hub opening is substantially circular.

According to preferred embodiments of the gear according to the present invention, the displacement means comprise a further inner hub rotationally engaging the gear hub, more particularly the edges, more in particular the inner edges, such that upon rotation of the gear hub around the inner hub, the centre of rotation of the gear ring is predeterminedly translated such as to create the predetermined backlash. As such configuration has been found to allow only very specific movements of the centre of rotation of the gear ring, it has been found that the predetermined translational movement of the centre of rotation of the gear ring can be relatively easy established. Furthermore, a rotational motion of the gear ring with respect to the gear hub, as for example seen during operation, will not influence the position of the centre of rotation of the ring gear.

According to more preferred embodiments of the gear according to the present invention, the inner hub and the gear hub are eccentrically positioned with respect to each other. It has been found that such configuration is a relative easy and reliable way to obtain the effect that upon rotation of the gear hub around the inner hub, the centre of rotation of the gear ring is predeterminedly translated such as to create the predetermined backlash.

According to more preferred embodiments of the gear according to the present invention, the gear hub opening is eccentric with respect to the gear ring.

According to alternative embodiments of the gear according to the present invention, the inner hub is eccentrically positioned in the gear hub opening and the gear hub opening is concentric with respect to the gear hub.

According to further preferred embodiments of the gear according to the present invention, the inner hub and the gear hub comprise at least one marking. The marking indicates the rotation to be followed by the gear hub around the inner hub such as to create the predetermined backlash. Such a gear further indicates to an operator mounting the gear to the at least one further gear how the predetermined translation of the centre of rotation of the gear ring can be obtained, making it even more easy to obtain the desired predetermined backlash. In addition it has been found that such marks can be easily applied without affecting the working of the gear ring, for example by printing, welding, soldering, forging, gluing, etc.

According to further preferred embodiments of the gear according to the present invention, the marking comprises a first pair of marks respectively on the inner hub and the gear hub indicating a first predetermined rotational position of the inner hub with respect to the gear hub in the first predetermined position in which the gear mates with the at least one further gear and a second pair of marks respectively on the inner hub and the gear hub indicating a second predetermined rotational position of the inner hub with respect to the gear hub in the second predetermined position in which the gear mates with the at least one further gear with the predetermined backlash. Such a gear further indicates to an operator mounting the gear to the at least one further gear how the predetermined translation of the centre of rotation of the gear ring can be obtained, making it even more easy to obtain the desired predetermined backlash. In addition it has been found that such marks can be easily applied without affecting the working of the gear ring, for example by printing, welding, soldering, forging, gluing, etc.

According to further preferred embodiments of the gear according to the present invention, at least one of the marks of the second pair of marks is one of marks of the first pair of marks. For example, the inner hub could only have one mark whereas the gear hub has two marks such that in the first predetermined position the mark of the inner hub coincides with a first of the marks on the gear hub and in the second predetermined position the mark of the inner hub coincides with the a second of the marks on the gear hub, different from the first of the marks on the gear hub. Alternatively, the gear hub could only have one mark whereas the inner hub has two marks such that in the first predetermined position the mark of the gear hub coincides with a first of the marks on the inner hub and in the second predetermined position the mark of the gear hub coincides with the a second of the marks on the inner hub, different from the first of the marks on the inner hub.

According to preferred embodiments of the gear according to the present invention, the gear comprises at least one bolting hole for fixing the gear hub by bolting. Such fixation of the gear hub has been found relatively easy to do and is reversible such that the predetermined backlash can be re-established after, for example, the gear had to be removed, for example, during reparations. The bolting hole may for example be located in the gear hub or in the inner hub.

According to preferred embodiments of the gear according to the present invention, the inner hub is connected to the gear hub with a transition fit. Such a fit has been found to allow rotation of the gear hub with respect to the inner hub, for example during assembly or reparation procedures, whereas, while the gear is in use, has a relative low risk that the predetermined backlash changes by movement of the gear hub with respect to the inner hub.

According to preferred embodiments of the gear according to the present invention, the inner hub comprises at least one bolting hole for fixing the position of the centre of rotation of the gear ring in the second predetermined position by bolting.

The invention also relates to a gear train with a gear, preferably an idler gear, according to the present invention, mating with at least one further gear, preferably at least two further gears.

According to preferred embodiments of the gear train according to the present invention, the gear mates with the at least one further gear with the predetermined backlash.

The invention also relates to an engine comprising the gear train according to the present invention.

The invention also relates to a method for mating a gear according to the present invention with at least one further gear with a predetermined backlash. According to such method, the gear ring rotationally mounted around the gear hub is mated with the at least one further gear in the first predetermined position with substantially no backlash after which the displacement means translate the centre of rotation of the gear ring predeterminedly by moving the gear ring and the gear hub with respect to the centre of rotation of the at least one further gear from the first predetermined position to the second predetermined position in which the gear mates with the at least one further gear with the predetermined backlash.

According to preferred embodiments of the method according to the present invention, the centre of rotation of the gear ring is translated from the first predetermined position to the second predetermined position by rotating the gear hub around the inner hub.

According to preferred embodiments of the method according to the present invention, after the centre of rotation of the gear ring has reached the second predetermined position, the gear hub is fixed with respect to the at least one further gear, preferably by bolting of, for example, by means of a transition fit.

According to preferred embodiments of the method according to the present invention, the inner hub is fixed with respect to the first and the second gear, preferably by bolting.

According to preferred embodiments of the method according to the present invention, a gear train according to the invention is made.

According to further preferred embodiments of the method according to the present invention, the gear ring rotationally mounted around the gear hub is mated with the at least two further gears in the first predetermined position with substantially no backlash.

According to preferred embodiments of the method according to the present invention, the engine according to the present invention is made.

The invention also relates to the use of the gear according to the present invention, the gear train according to the present invention and/or the engine according to the present invention.

Other details and advantages of the invention will become apparent from the enclosed figures and description of embodiments of the invention.

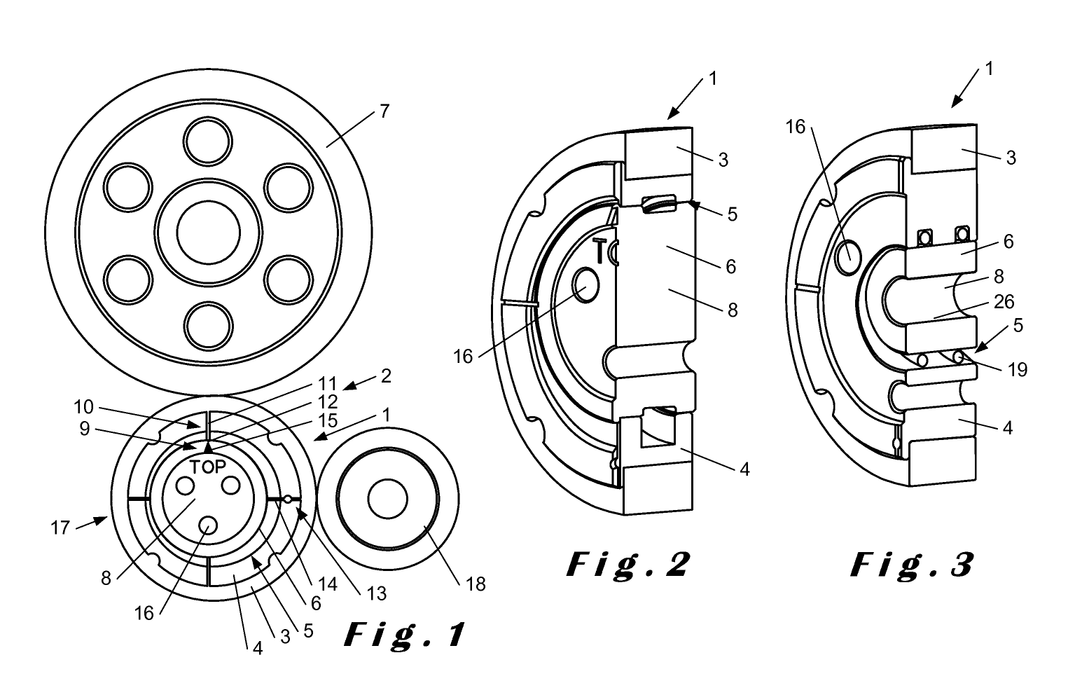

FIG. 1 shows an overview of a gear train with a gear according to the present invention.

FIG. 2 shows a sectional view of the gear shown in FIG. 1.

FIG. 3 shows an alternative embodiment of the gear shown in FIGS. 1 and 2.

The gear 1 shown in FIG. 1 mates with a first 7 and a second 18 further gear and thus forms a gear train 17. The gear 1 shown in FIG. 1 more specifically is an idler gear 2, although this is not critical for the present invention. The gear train 17 can be part of an engine, for example a car engine, although not shown in the figures.

The gear 1 comprises a gear ring 3 which is rotationally mounted around a gear hub 4. The gear ring 3 is shown schematically in FIG. 1 and no details, such as for example gear teeth applied circumferentially along the circumference of the gear ring 3, are shown. Usually the gear ring 3 is made of metal, although not critical for the present invention, and the gear ring 3 can also be made of, for example, a polymer material depending on the desired characteristics of the gear ring 3 on its turn depending on the desired application of the gear 1.

The gear hub 4 provides a rotational mount for the gear ring 3 and thereto is for example provided with a rotational bearing, for example a ball bearing, a bearing bush, etc. The bearing for reasons of clarity of the figures is not shown in the figures.

Usually the gear hub 4 is made of metal, although not critical for the present invention, and the gear hub 4 can also be made of, for example, a polymer material depending on the desired characteristics of the gear hub 4 on its turn depending on the desired application of the gear 1.

The gear hub 4 comprises an axial gear hub opening 5. In the embodiment shown in the figures, the gear hub opening 5 is substantially circular. This is however not critical for the invention and the hub opening 5 could have other shapes as deemed appropriate by the person skilled in the art.

As shown in FIGS. 1 and 2, the gear hub opening 5 is eccentric with respect to the gear ring 3. However, as shown in FIG. 3, the opening can also be concentric with respect to the gear ring 3 and the gear hub 4.

The gear 1 further comprises displacement means 6 in the gear hub opening 5. The displacement means 6 are provided for predeterminedly translating the centre of rotation of the gear ring 3 by moving the gear ring 3 and the gear hub 4 with respect to the centre of rotation of at least one further gear 7 from a first predetermined position in which the gear mates with the at least one further gear with substantially no backlash to a second predetermined position in which the gear mates with the at least one further gear with a predetermined backlash.

As shown in FIGS. 1-3, the displacement means 6 further preferably comprise an inner hub 8 rotationally engaging the gear hub 4 such that upon rotation of the gear hub 4 around the inner hub 8, the centre of rotation of the gear ring 3 is predeterminedly translated such as to create the predetermined backlash. The inner hub 8 thereto is positioned eccentric with respect to the gear ring 3 and the gear hub 4.

As shown in FIG. 2, the inner circumference of the hub opening 5 rotationally engages the inner hub 8, more in particular the outer surface of the inner hub 8. Thereto, the inner circumference could comprise a pair of sealing rings or alternative spacing elements 19 as shown in the embodiments shown in FIG. 3 but not shown in FIG. 2. The pair of sealing rings or alternative spacing elements 19, if present, may be concentric with respect to the gear hub 4, as would be the case in the embodiment according to FIG. 2, or may be eccentric with respect to the gear hub 4, as shown in FIG. 3.

The eccentric position of the inner hub 8 in the gear hub 3 may for example be provided for by the eccentric positioning of the rotational bearing 19 inside the gear hub opening 5, as shown in FIG. 3, or may for example be provided for by the eccentric positioning of the gear hub opening 5 itself, as shown in FIG. 2, or even a combination of the two, not shown.

The rotational bearing can be any type of rotational bearing deemed appropriate by the person skilled in the art, for example a ball bearing, etc.

As shown in the figures, the gear 1 preferably comprises at least one bolting hole 16 for fixing the gear hub 4 by bolting. As shown in FIG. 2, the bolting hole 16 can be provided in the gear hub 4 or can for example be provided in the inner hub 8.

In case the inner hub 8 comprises the at least one bolting hole 16 for fixing the position of the centre of rotation of the gear ring 3 in the second predetermined position by bolting, as for example shown in FIG. 2, the rolling resistance of the gear ring 3 when rotating around the gear hub 4 preferably is smaller, preferably substantially smaller, than the rolling resistance of the gear hub 4 when rotating around the inner hub 8. In FIG. 3, for example, the at least one bolting hole 16 is provided in the gear hub 4, allowing the inner hub 8 to be mounted inside the gear hub opening 5 with for example a pair of sealing rings or alternative spacing elements 19.

As shown in the figures, the inner hub 8 and the gear hub 4 preferably comprise at least one marking 9 indicating the rotation to be followed by the gear hub 4 around the inner hub 8 such as to create the predetermined backlash. As shown in the figures, the marking 9 preferably comprises a first pair 10 of marks 12, 11 respectively on the inner hub 8 and the gear hub 4 indicating a first predetermined rotational position of the inner hub 8 with respect to the gear hub 4 in the first predetermined position in which the gear 1 mates with the at least one further gear 7 and a second pair 13 of marks 15, 14 respectively on the inner hub 8 and the gear hub 4 indicating a second predetermined rotational position of the inner hub 8 with respect top the gear hub 4 in the second predetermined position in which the gear 1 mates with the at least one further gear 7 with the predetermined backlash.

As especially shown in for example FIG. 1, the inner hub 8 comprises a triangular indicator 12 with the indication “TOP” to indicate that the triangle 12 should be situated at the mark 11 marked on the ring hub 4 when putting the gear 1 in the first predetermined position with respect to the further gear 7. When the gear hub 4 is then rotated clockwise with respect to the inner hub 8 till the mark 12 coincides with the mark 14 on the gear hub 4 of the pair 13, the centre of rotation of the gear ring 3 is translated by moving the gear ring 3 and the gear hub 4 with respect to the centre of rotation of at least one further gear 7 from the first predetermined position in which the gear mates with the at least one further gear with substantially no backlash to the second predetermined position in which the gear mates with the at least one further gear with a predetermined backlash. In such an embodiment, at least one of the marks of the second pair of marks is one of the marks of the first pair of marks. In the case shown in FIG. 1, the inner hub has one mark whereas the gear hub has at least two marks such that in the first predetermined position the mark of the inner hub coincides with a first of the marks on the gear hub and in the second predetermined position the mark of the inner hub coincides with the a second of the marks on the gear hub, different from the first of the marks on the gear hub.

As can be seen in the figures additional marks can be added to the gear 1, for example to further increase the accuracy with which the inner hub 8 can be positioned inside the gear hub 4.

To mount the gear 1 according to FIG. 2 in a gear train with a predetermined backlash, the gear 1 shown in FIG. 2 will first be positioned with the centre of rotation of the gear ring 3 in the first predetermined position after which it will be fastened in the gear train by using the bolting holes 16. Then, the inner hub 8 will be rotated such as to bring the centre of rotation of the gear ring 3 to the second predetermined position, using the preferred transition fit between the inner hub 8 and the gear hub 4. While in use, the gear ring 3 will rotate around the gear hub 4, whereas due to the relative larger resistance to rolling, the gear hub 4 will substantially retain its position with respect to the inner hub 8.

To mount the gear 1 according to FIG. 3 in a gear train with a predetermined backlash, the gear 1 shown in FIG. 3 will first be positioned with the centre of rotation of the gear ring 3 in the first predetermined position after which it will be fastened in the gear train by using the at least one additional bolting hole 26 in the inner hub 8. Then, the gear hub 4 will be rotated with respect to the inner hub 8 such as to bring the centre of rotation of the gear ring 3 to the second predetermined position, using the preferred sealing rings or alternative spacing elements 19 as shown in FIG. 3. When the centre of rotation of the gear ring 3 reaches the second predetermined position, the gear 1 is bolted in this location using the at least one bolting hole 16. The bolt fixing the gear 1 using the additional bolting hole in the inner hub 8 using the bolting hole 26 can then be removed or can remain. The means for fixing the gear 1 using the bolting hole 16 are preferably provided to accommodate the movement of the centre of rotation of the gear ring 3 from the first to the second predetermined position. For example, the bolting hole 16 can have a diameter and/or shape allowing a bolt provided through it with some leeway during movement of the centre of rotation of the gear ring 3. On the other hand, the hole in the piece to which the gear 1 is attached can be provided with holes providing the necessary leeway for the bolt extending through the bolting hole 16. While in use, the gear ring 3 will rotate around the gear hub 4, whereas due to the relative larger resistance to rolling, the gear hub 4 will substantially retain its position with respect to the inner hub 8.

1. A gear, for example an idler gear, comprising a gear ring rotationally mounted around a gear hub, the gear hub comprising an axial gear hub opening, wherein the gear comprises displacement means in the gear hub opening, the displacement means being provided for predeterminedly translating the centre of rotation of the gear ring by moving the gear ring and the gear hub with respect to the centre of rotation of at least one further gear from a first predetermined position in which the gear mates with the at least one further gear with substantially no backlash to a second predetermined position in which the gear mates with the at least one further gear with a predetermined backlash.

2. The gear according to claim 1, wherein the gear hub opening is substantially circular.

3. The gear according to claim 2, wherein the displacement means comprise a further inner hub rotationally engaging the gear hub such that upon rotation of the gear hub around the inner hub, the centre of rotation of the gear ring is predeterminedly translated such as to create the predetermined backlash.

4. The gear ring according to claim 3, wherein the inner hub and the gear hub are eccentrically positioned with respect to each other.

5. The gear ring according to claim 4, wherein the gear hub opening is eccentric with respect to the gear ring.

6. The gear ring according to claim 4, wherein the inner hub is eccentrically positioned in the gear hub opening and wherein the gear hub opening is concentric with respect to the gear hub.

7. The gear according to claim 3, wherein the inner hub and the gear hub comprise at least one marking indicating the rotation to be followed by the gear hub around the inner hub such as to create the predetermined backlash.

8. The gear according to claim 7, wherein the marking comprises a first pair of marks respectively on the inner hub and the gear hub indicating a first predetermined rotational position of the inner hub with respect to the gear hub in the first predetermined position in which the gear mates with the at least one further gear and a second pair of marks respectively on the inner hub and the gear hub indicating a second predetermined rotational position of the inner hub with respect to the gear hub in the second predetermined position in which the gear mates with the at least one further gear with the predetermined backlash.

9. The gear according to claim 3, wherein the gear comprises at least one bolting hole for fixing the gear hub by bolting.

10. The gear according to claim 3, wherein the inner hub is connected to the gear hub with a transition fit.

11. The gear according to claim 3, wherein the inner hub comprises at least one bolting hole for fixing the position of the centre of rotation of the gear ring in the second predetermined position by bolting.

12. A gear train with a gear, preferably an idler gear, as claimed in claim 1 mating with at least one further gear, preferably at least two further gears.

13. The gear train as claimed in claim 12, wherein the gear mates with the at least one further gear with the predetermined backlash.

14. An engine comprising the gear train according to claim 12.

15. A method for mating a gear according to claim 1 with at least one further gear with a predetermined backlash, wherein the gear ring rotationally mounted around the gear hub is mated with the at least one further gear in the first predetermined position with substantially no backlash after which the displacement means translate the centre of rotation of the gear ring predeterminedly by moving the gear ring and the gear hub with respect to the centre of rotation of the at least one further gear from the first predetermined position to the second predetermined position in which the gear mates with the at least one further gear with the predetermined backlash.

16. The method according to claim 15 for mating a gear, wherein the gear hub opening is substantially circular, wherein the displacement means comprise a further inner hub rotationally engaging the gear hub such that upon rotation of the gear hub around the inner hub, the centre of rotation of the gear ring is predeterminedly translated such as to create the predetermined backlash, with at least one further gear with a predetermined backlash, wherein the centre of rotation of the gear ring is translated from the first predetermined position to the second predetermined position by rotating the gear hub around the inner hub.

17. The method according to claim 16 for mating a gear, wherein the gear comprises at least one bolting hole for fixing the gear hub by bolting, with at least one further gear with a predetermined backlash, wherein after the centre of rotation of the gear ring has reached the second predetermined position, the gear hub is fixed with respect to the at least one further gear, preferably by bolting.

18. The method according to claim 17 for mating a gear wherein the inner hub comprises at least one bolting hole for fixing the position of the centre of of the gear ring in the second predetermined position by bolting, with at least one further gear with a predetermined backlash, wherein the inner hub is fixed respect to the at least one further gear, preferably by bolting.

19. The method according to claim 15 for making a gear train preferably an idler gear, mating with at least one further gear, preferably at least two further gears.

20. The method according to claim 19, wherein the gear ring rotationally mounted around the gear hub is mated with the at least two further gears in the first predetermined position with substantially no backlash.

21. The method according to claim 19 for making an engine comprising the gear train.

22. Use of the gear according to claim 1, the gear train with a gear, preferably an idler gear mating with at least one further gear, preferably at least two further gears and/or an engine comprising the gear train.
